(19) United States
(12) Patent Application Publication
(10) Pub. No.: US 2026/0050743 A1
(43) Pub. Date: Feb. 19, 2026

(54) SYSTEMS AND METHODS FOR ASSESSING AND IMPROVING DATA INTEROPERABILITY OF LARGE-LANGUAGE MODELS

(71) Applicant: ACCENTURE GLOBAL SOLUTIONS LIMITED, Dublin 4 (IE)

(72) Inventors: Nimrod BUSANY, Tel Aviv (IL); Gil ROSENBLUM, Tel Aviv (IL); Hananel HADAD, Givat Shmuel (IL); Eitan HADAR, Nesher (IL); Zofia MASZLANKA, Jatne (PL)

(73) Assignee: ACCENTURE GLOBAL SOLUTIONS LIMITED, Dublin 4 (IE)

(21) Appl. No.: 19/292,681

(22) Filed: Aug. 6, 2025

Related U.S. Application Data
(60) Provisional application No. 63/684,081, filed on Aug. 16, 2024.

(51) Int. Cl. G06F 40/30; G06F 16/383

(52) U.S. Cl. CPC G06F 40/30; G06F 16/383

(57) ABSTRACT

A system and a method for assessing and improving data interoperability of large language models (LLMs) are disclosed. The method includes receiving metadata associated with a data model, determining an interpretability level of the data model by the LLM, computing a performance score for each entity of the plurality of entities based on the determined interpretability level, generating a performance report including semantic attributes and deficiencies of the data model, determining semantic modifications to be performed to each of the plurality of entities, constructing a dependency graph for each entity to identify an impact of the at least one semantic modification on related entities, fine-tuning the data model with the at least one semantic modification based on the constructed dependency graph, integrating the fine-tuned data model with at least one Gen AI application, and updating database schemas corresponding to the fine-tuned data model based on the integrated Gen AI application.

### CROSS-REFERENCE TO RELATED PATENT APPLICATIONS

This application claims priority to U.S. Provisional Application No. 63/684,081, filed on Aug. 16, 2024, the entire content of which is hereby incorporated by reference in the entirety for all purposes.

### TECHNICAL FIELD

The present disclosure generally relates to the field of large language models and, more particularly, to systems and methods for assessing and improving data interoperability of large language models.

### BACKGROUND

Artificial intelligence (AI) systems, especially those powered by Large Language Models (LLMs), depend heavily on high-quality, well-structured data during training and deployment. However, many existing enterprise information systems were not originally designed to support the requirements of modern LLMs and Generative AI (GenAI) technologies. For example, the existing information system (data models) may be suboptimal due to the factors such as ambiguous entity names, unclear annotations and inappropriate or imprecise relationship definitions or combinations thereof. As a result, there is a growing disconnect between the capabilities of AI systems and the readiness of organizational data environments. This misalignment poses significant risks for businesses, including poor model performance, increased implementation costs, and delayed innovation. Organizations aiming to develop GenAI solutions may encounter challenges, as these solutions may rely heavily on organizational data to support business operations.

Organizations looking to harness GenAI to enhance decision-making, automate processes, or improve customer experiences often face major data-related challenges. GenAI solutions rely on diverse, up-to-date, and contextually rich data to deliver meaningful insights and outputs. Yet, much of this data is locked in siloed systems, unstructured formats, or legacy platforms with limited interoperability. Business and data leaders must now address a wide range of evolving needs such as equipping business analysts with the ability to interpret the semantics of data schemas, models, and objects, identifying and cataloging potential data sources, attributes, and their relevance to use cases, defining the necessary datasets to support advanced analytics, predictive modeling, and real-time reporting, integrating and organizing data across fragmented and legacy systems to ensure consistency, accessibility, and scalability, and managing the evolution and modernization of existing Business Intelligence (BI) systems to align with AI-driven transformation goals.

### SUMMARY

This summary is provided to introduce a selection of concepts in a simple manner that is further described in the detailed description of the disclosure. This summary is not intended to identify key or essential inventive concepts of the subject matter, nor is it intended for determining the scope of the disclosure.

Systems and methods for assessing and improving data interoperability of large language models are disclosed. The method includes receiving metadata associated with at least one data model from a plurality of data sources, wherein the at least one data model includes a plurality of entities having classes, data properties, and object properties, determining an interpretability level of the data model by at least one Large Language Model (LLM) by evaluating the plurality of entities based on a set of predefined criteria, wherein the set of predefined criteria includes an informativeness level, an ambiguity level, a completeness level, a relevance level, and a consistency level, and computing a performance score for each entity of the plurality of entities based on the determined interpretability level, wherein the performance score includes a numerical score and an explanation for each entity based on the set of predefined criteria. The method further includes generating a performance report comprising semantic attributes and deficiencies of the data model, wherein the readiness report includes an overall ontology score calculated as a weighted average of the computed performance score assigned to the plurality of entities, determining at least one semantic modification to be performed to each of the plurality of entities using the LLM, wherein the at least one semantic modification includes renaming entities, adding annotations, incorporating statistical metadata, and generating task-specific instructions for GenAI applications, constructing a dependency graph for each entity to identify an impact of the at least one semantic modification on related entities, wherein the dependency graph includes a plurality of relationships between the plurality of entities based on corresponding semantic connections in the data model, and fine-tuning the data model with the at least one semantic modification based on the constructed dependency graph using a Generative Artificial Intelligence model. Further, the method includes integrating the fine-tuned data model with at least one Generative Artificial Intelligence (Gen AI) application and updating database schemas corresponding to the fine-tuned data model based on the integrated Generative Artificial Intelligence (Gen AI) application.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment including a system for assessing and improving data interoperability of large language models, in accordance with an embodiment of the present disclosure;

FIG. 2 depicts a block diagram of the system, in accordance with an embodiment of the present disclosure;

FIG. 3 is a block diagram illustrating sub-modules of the interpretability level determination module, in accordance with an embodiment of the present disclosure;

FIG. 4 is a flowchart illustrating a method for assessing and improving data interoperability of large-language-models, in accordance with an embodiment of the present disclosure; and

FIG. 5 illustrates a computer system that may be used to implement the system disclosed in the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of embodiments. However, it will be understood by one of the ordinary skills in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe systems and methods for assessing and improving data interoperability of large language models. Initially, the system receives metadata associated with at least one data model from a plurality of data sources, wherein the at least one data model includes a plurality of entities having classes, data properties, and object properties. The data model as described herein refers to a structure that defines how data is stored, organized, and related in a system, usually for databases, applications, or software systems. Upon receiving, the system determines the interpretability level of the data model by at least one Large Language Model (LLM) by evaluating the plurality of entities based on a set of predefined criteria. The set of predefined criteria includes an informativeness level, an ambiguity level, a completeness level, a relevance level, and a consistency level. Then the system computes a performance score for each entity of the plurality of entities based on the determined interpretability level, wherein the performance score includes a numerical score and an explanation for each entity based on the set of predefined criteria.

Then the system generates a performance report having semantic attributes and deficiencies of the data model, wherein the readiness report includes an overall ontology score calculated as a weighted average of the computed performance score assigned to the plurality of entities. Further, the system determines at least one semantic modification to be performed to each of the plurality of entities using the LLM, wherein the at least one semantic modification includes renaming entities, adding annotations, incorporating statistical metadata, and generating task-specific instructions for GenAI applications. Upon determining the semantic modifications, the system constructs a dependency graph for each entity to identify an impact of the at least one semantic modification on related entities, wherein the dependency graph includes a plurality of relationships between the plurality of entities based on corresponding semantic connections in the data model. Then the system fine-tunes the data model with the at least one semantic modification based on the constructed dependency graph using a Generative Artificial Intelligence model. Furthermore, the system integrates the fine-tuned data model with at least one Generative Artificial Intelligence (Gen AI) application and updates database schemas corresponding to the fine-tuned data model based on the integrated Gen AI application. Hence, the proposed system analyses a given data models and finetunes to meet the requirements of modern GenAI applications.

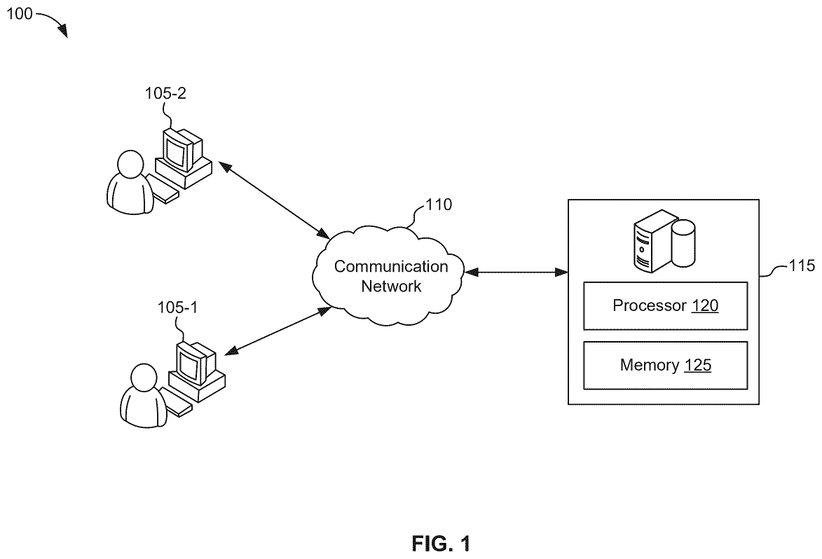

FIG. 1 depicts an example environment including a system for assessing and improving data interoperability of large language models, in accordance with an embodiment of the present disclosure. As shown, environment 100 includes a plurality of data sources (shown only two data sources 105-1 and 105-2), a communication network 110 and a system 115, wherein the plurality of data sources 105 and the system 115 are communicatively connected over the communication network 110.

The data sources 105 may be a part of the system 115 itself or may be external to the system 115 as shown. For example, the data sources may include a desktop, a server, and a combination of servers. The data sources 105 may present one or more user interfaces (e.g., Graphical User Interfaces (GUIs)) of a workspace for the user to interact with the system 115. The data sources 105 may be used to provide input and/or receive output to/from the system 115. The input or the input data may include data corresponding to a GenAI application.

In some examples, the communication network 110 includes a Local Area Network (LAN), a Wide Area Network (WAN), the Internet, or a combination thereof, and connects plurality of data sources 105 and systems 115. In some examples, the communication network 110 may be accessed over a wired and/or a wireless communication link. For example, a computing device like smartphone may utilize a cellular network to access the communication network 110.

In an example embodiment, the system 115 may be implemented as an on-premises system that is operated by an enterprise or a third-party engaged in cross-platform interactions and data management. In some examples, the system 115 may be implemented as an off-premises system (for example, cloud or on-demand) that is operated by an enterprise or a third-party on behalf of an enterprise. In some examples, the system 115 may be implemented in a cloud environment. For simplicity, the system 115 depicted in FIG. 1 may be a cloud environment that is intended to represent various forms of servers including a web server, an application server, a proxy server, a network server, a server pool, and/or the like.

In some examples, the system 115 may be implemented by way of a single device or a combination of multiple devices that may be operatively connected or networked together. The system 115 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications. Referring to FIG. 1, the system 115 includes a processor 120 and a memory 125 communicably coupled to the processor 120. The processor 120 may include one or more processors. Examples of the processor 120 may include, but are not limited to, microprocessors, microcomputers, microcontrollers, digital signal processors, central processing units, state machines, logic circuits, and/or any devices that manipulate data or signals based on operational instructions. Among other capabilities, the processor 120 may fetch instructions (also be referenced to as processor-executable instructions or machine-executable instructions) from the memory 125 and execute the fetched instructions for performing operations according to the present disclosure. The memory 125 may be non-volatile or non-transitory computer-readable medium (CRM) such as, a magnetic disk or solid-state non-volatile memory or volatile medium such as Random Access Memory (RAM), and/or the like.

In an example embodiment of the present disclosure, the system 115 is configured for assessing and improving data interoperability of Large Language Models (LLMs). Specifically, the system 115 is configured to enhance the structure and quality of existing data models that may be suboptimal due factors such as ambiguous entity names, unclear annotations and inappropriate or imprecise relationship definitions. To enhance the structure and quality of existing data models, the system 115 analyses and refines the said factors and then generates a revised, structured data models that supports improved automatic processing and facilitates better understanding and reasoning by the LLMs.

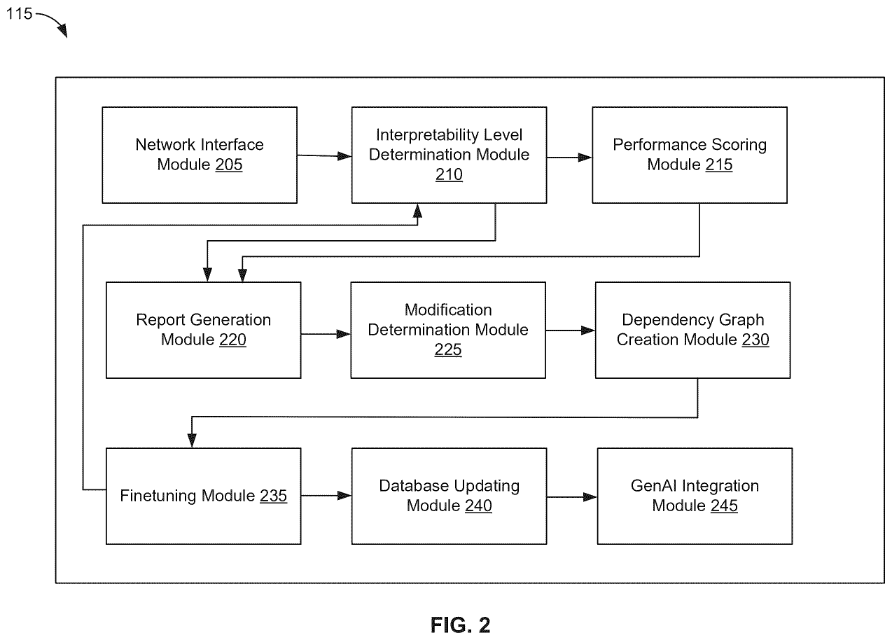

FIG. 2 depicts a block diagram of the system, in accordance with an embodiment of the present disclosure. As shown, in addition to the processor 120 and the memory 125, the system 115 includes a network interface module 205 enabling communication between the system 115 and the plurality of data sources 105, an interpretability level determination module 210, a performance scoring module 215, a report generation module 220, a modification determination module 225, dependency graph creation module 230, a finetuning module 235 a database updating module 240 and a GenAI integration module 245.

As described, the system 115 is configured for assessing and improving data interoperability of Large Language Models LLMs. Initially, a user may input a data model into the system 115. That is, the system 115 is configured to receive metadata associated with at least one data model from one or more data sources 105. The data model provides a structured representation of the data and processes involved in building, training, fine-tuning, and deploying an LLM. Hence, the data model includes a plurality of entities having classes, data properties, and object properties. The metadata associated with the data model includes but is not limited to entity names, annotations, data properties, object properties, sample data, domain-specific terms, and relationships with other entities.

Upon receiving the data model, the interpretability level determination module 210 determines the interpretability level of the data model by LLM, wherein the interpretability level determination module 210 determines the interpretability level by evaluating the plurality of entities based on a set of predefined criteria. In an embodiment, the set of predefined criteria includes an informativeness level, an ambiguity level, a completeness level, a relevance level, and a consistency level of the data model.

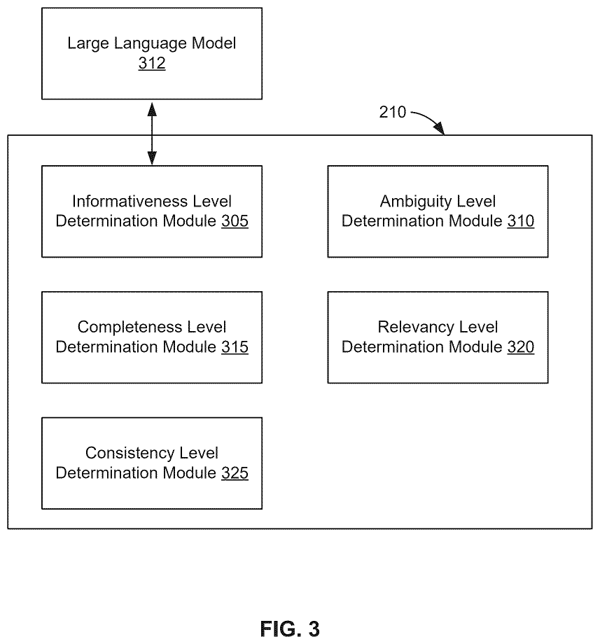

FIG. 3 is a block diagram illustrating sub-modules of the interpretability level determination module, in accordance with an embodiment of the present disclosure. As shown, the interpretability level determination module 115 includes an informativeness level determination module 305, an ambiguity level determination module 310, a completeness level determination module 315, a relevance level determination module 320 and a consistency level determination module 325.

In one embodiment of the present disclosure, the interpretability level determination module 210 accesses the metadata associated with the data model to determine the interpretability level of the data model by an LLM. The metadata associated with the data model may be accessed from the ontology files, relational schema, and NoSQL/JSON schemas. Then the interpretability level determination module 210 processes the accessed metadata, using the informativeness level determination module 305 to assess the informativeness level of the data model by determining each entity name and associated attributes indicating a purpose of the entity using the LLM. That is, the informativeness level determination module 305 determines how informative each entity of the data model is in defining the purpose and role in the LLM. For example, the informativeness level of an entity may be determined based on whether the entity name clearly suggests the role of the entity (for example, Prompt, TrainingRun, and EvaluationMetric), whether the annotations provide clear descriptions or usage notes, whether data properties cover key descriptive and functional aspects (for example, timestamps, hyperparameters, and token counts), whether domain-specific terms align with LLM practices and vocabulary, etc. In an embodiment of the present disclosure, the informativeness level determination module 305 uses an LLM 312 for determining the informativeness level of each entity of the data model. In this implementation, the LLM 312 is finetuned to predict the informativeness level and assign a score for a given entity based on the entity names, annotations, data properties, object properties, domain-specific terms, and entity relationships. The informativeness level determination module 305 uses an LLM 312 for determining the informativeness level of each entity of the data model. That is, upon receiving the metadata of an entity, the informativeness level determination module 305 feeds the metadata to the LLM 312 in a structured form, for example in JASON format. Further, the informativeness level determination module 305 uses the prompts to guide the LLM 312 to assess the informativeness level of the entity and provide the informativeness score for the entity. For example, for a given entity, a score may be assigned for clarity, annotation quality, attribute appropriateness, relationship coherence, etc., and weighted average may be used to compute the informativeness level (informativeness score) for each entity and for the whole data model. For example, the informativeness score for each entity is calculated as a weighted average of several factors, including clarity, annotation quality, attribute appropriateness, and relationship coherence. The overall informativeness score for the entire data model is then determined by averaging the informativeness scores of all its entities. In another implementation, other methods such as natural language-based methods, rule-based scoring methods, and ontology-based heuristics may be used to determine the informativeness level of the entities of the data model.

Further, the interpretability level determination module 210 processes the accessed metadata, using the ambiguity level determination module 310, to assess the ambiguity level of the data model by determining each entity name having multiple interpretations, evaluated independently and relatively to the plurality of entities in the data model. That is, the ambiguity level determination module 310 assesses how ambiguous the data model is, by evaluating each entity name independently, by checking whether an entity name has different meanings. Further, the ambiguity level determination module 310 assesses how ambiguous the data model is, by evaluating relatively, that is by checking whether an entity name causes any confusion in the context of other entities in the data model. In an embodiment, independent ambiguity check may be performed using internal or external knowledgebases, and independent ambiguity scores may be assigned based on the number of matches. For example, based on the number of matching words, a score between zero and one is assigned. In another embodiment, an LLM may be used to perform the independent ambiguity check and to assign the independent ambiguity scores. In an embodiment, the relative ambiguity check is performed by identifying semantically overlapping names in the data model. In one implementation, vector embeddings are used to compute similarity between entity names, and a relative ambiguity score (between zero and one) is assigned based on the match. Upon assigning the independent ambiguity scores and the relative ambiguity score, a final ambiguity score (ambiguity level) is computed by weighted average, for example. Further, a an overall informativeness score for the entire data model is then determined by averaging the final ambiguity scores of all the entities of the data model.

In an embodiment of the present disclosure, the interpretability level determination module 210 is further configured for assessing the completeness level of the data model using the completeness level determination module 315. The completeness level determination module 315 assesses each entity name indicating data represented by the entity. That is, the completeness level determination module 315 automatically assesses how complete the data model is, by checking whether each entity clearly and sufficiently defines the type of data it represents. To determine the completeness level, the completeness level determination module 315 uses the metadata such as the entity name, the annotations, the data properties, the object properties, and sample values, etc. In one implementation, rule-based or NLP methods are used to evaluate whether the names use domain-relevant terms. Further, rules may be used to check whether an entity has enough attributes to support its intended role. For example, rules may include minimum number of descriptive data properties for an entity, properties matching expected domain values, etc. Further, NLP methods (such as embedding similarity or keyword matching) are used to check alignment between the entity names, annotations and properties, and a score is assigned to each property such as name clarity score, property coverage score, annotation quality score, etc. Further, the completeness level determination module 315 computes a final completeness score (completeness level) by computing the weighted average of the name clarity score, the property coverage score and the annotation quality score. Furthermore, an overall completeness score for the entire data model is then determined by averaging the completeness scores of all the properties of the data model.

Furthermore, the interpretability level determination module 210 determines the relevance level of the data model, using the relevance level determination module 320. The relevance level determination module 320 determines the relevance level of the data model by determining each entity name corresponding to data attributes of the entity. That is, the relevance level determination module 320 evaluates whether the attributes defined for an entity support or represent what the entity name implies, to measure how relevant and well-structured the data model is. For example, an entity is highly relevant if the entity name describes a specific concept, the attributes clearly belong to that concept, and there is no mismatch or unrelated properties. To determine the relevance level (relevance score), the module uses the metadata such as the entity names, the data attributes, the annotations and comments. Then the relevance level determination module 320 uses the entity name to infer the concept it represents, wherein the inference may be performed using word embeddings, ontology matching or keyword look up or using an LLM. Then, how well each attribute matches the expected concept is evaluated using semantical similarity between the entity name and each attribute. Then the relevancy score is assigned to each entity of the data model. Further, an overall relevancy score for the entire data model is then determined by averaging the relevancy scores of all the entities of the data model.

Furthermore, the interpretability level determination module 210 assesses the consistency level of the data model using the consistency level determination module 325. The consistency level determination module 325 analyses the entity names to check if the entity names are being uniformly applied across the data model to indicate similar concepts. That is, the consistency level determination module 325 processes the metadata to determine how consistent the data model is, by checking whether similar concepts are represented using consistent, uniform entity names and/or the domain-specific terms throughout the data model. The consistency may be determined based on the labels assigned to similar concepts and different concepts, naming conventions, and synonyms or contradictory names. In an embodiment, the consistency level determination module 325 processes the metadata to determine the consistency level (consistency score). In an embodiment, the consistency level determination module 325 uses semantic similarity methods to detect if multiple entity names refer to the same or related concepts. The semantic similarity methods may include but are not limited to embedding similarity, synonym detection, string similarity, and ontology-based mapping. The consistency level determination module 325 detects for the issues such as if multiple names used for the same concept (synonym overlap), same name used for multiple distinct concepts, inconsistent naming patterns, prefix/suffix misuse, etc. Then the consistency level determination module 325 assigns a consistency score for each entity or a group of entities. In one implementation, a semantic overlap score, a naming convention score, and a naming redundancy score are computed and then a weighted average is computed to compute the final consistency score. Further, an overall consistency score for the entire data model is then determined by averaging the consistency scores of all the entities of the data model.

As described, the interpretability level determination module 210 determines the interpretability level of the data model by the LLM by evaluating the plurality of entities based on a set of predefined criteria, wherein the set of predefined criteria includes the informativeness level, the ambiguity level, the completeness level, the relevance level, and the consistency level. That is, the interpretability level determination module 210 assigns an informativeness score, an ambiguity score, a completeness score, a relevance score and a consistency score for the data model.

Upon determining the scores, the interpretability level determination module 210 identifies the areas of the data model that are weak or suboptimal (for example, incomplete, ambiguous, or lacking relevance) based on the determined scores. Then, the interpretability level determination module 210 embeds additional contextual information to the data model, wherein the additional contextual information is derived from the data source descriptions and data from external sources. The data source description provides details about where each piece of data originated, such as its provenance, credibility, and collection method. The external sources provide information from third-party systems or datasets that help fill gaps, clarify ambiguities, or reinforce consistency. For example, if the ambiguity score of the data model is greater than a predefined threshold value (indicating vague labels or poorly defined terms), then the interpretability level determination module 210 determines the type of the contextual information needed from the data source metadata, external linked data, and/or domain ontologies, by querying external APIs or linked data sources for example. The retrieved contextual information is then integrated into the data model as annotations or metadata to the entities or attributes. Similarly, all the scores are compared to the corresponding predefined thresholds and additional contextual information is embedded into the data model.

Upon embedding the contextual information, the interpretability level determination module 210 further determines the interpretability level of the data model by at least one LLM by evaluating the entity names based on the embedded additional contextual information, the informativeness level, the ambiguity level, the completeness level, the relevance level, and the consistency level as described with reference to FIG. 2 and FIG. 3. In one implementation, the interpretability level (interpretability score) is computed for each entity and includes the informativeness score, the ambiguity score, the completeness score, the relevance score, and the consistency score.

Referring to FIG. 2, upon determining the interpretability level, the performance scoring module 215 computes a performance score for each entity of the plurality of entities based on the determined interpretability level, wherein the performance score includes a numerical score and an explanation for each entity based on the set of predefined criteria. In an embodiment, to compute the performance score for each entity, the performance scoring module 215 uses the informativeness score, the ambiguity score, the completeness score, the relevance score, and the consistency score of each entity, and generates an explanation for each entity's interpretability score. In one implementation, a Large Language Model (LLM) is used to generate explanation for each entity's interpretability score. The explanation includes a justification or degree of compliance for each interpretability dimension.

Further, the performance scoring module 215 computes a plurality of local scores for each entity independently of subsequent entities in the data model and also computes a plurality of global scores for each entity relative to the subsequent entities in the data model based on inter-entity relationships, wherein the inter-entity relationships include semantic connections affecting the ambiguity level and the consistency level. That is, the performance scoring module 215 computes the local scores for each entity in isolation (without considering its relationship with other entities) to evaluate inherent qualities, for example how informative or complete the entity is by itself. In an embodiment, the local score for an entity is computed as a combination of the informativeness score, the ambiguity score, the completeness score, the relevance score, and the consistency score and using predefined or learned weights. Further, the performance scoring module 215 computes a global score for the entities to assess how well an entity behaves in relation to other entities in the data model. This focuses on inter-entity semantics, addressing how ambiguity and consistency are influenced by the broader model context. Hence, the global score of an entity is computed as a weighted combination of the ambiguity score and the consistency score of the entity. In an example, considering the ambiguity score=0.6 and consistency score=0.7 for a given entity, and weights as 0.5 for both, then the global score is computed as:

Global Score=(0.5×(1−0.6)+(0.5×0.7))=(0.5×0.4)+(0.5×0.7)=(0.2+0.35)=0.55

Then the performance scoring module 215 aggregates the local scores and the global scores to generate the performance score for each entity, wherein the performance score indicates the interpretability level of the entity within the data model. In an embodiment, the final performance score for each entity is computed based on weighted averaging, rule-based scoring, or learned fusion models. The performance score (a composite score) reflects both the inherent quality of the entity and its contextual coherence within the data model and represents the overall interpretability level of the entity.

Upon computing the performance score for each entity, the report generation module 220 generates a performance report having semantic attributes and deficiencies of the data model, wherein the readiness report includes an overall ontology score calculated as a weighted average of the computed performance score assigned to the plurality of entities. That is, the report generation module 220 generates a comprehensive performance report that captures the semantic quality of the data model, highlights strengths and weaknesses in interpretability, and recommends semantic improvements using structured evaluation criteria. Initially, the report generation module 220 aggregates the performance score for each entity of the plurality of entities to calculate an overall ontology score as the weighted average based on the informativeness score, the ambiguity score, the completeness score, the relevance score, and the consistency score. As described with reference to interpretability level determination module 210, each entity is scored based on five interpretability dimensions such as informativeness, ambiguity, completeness, relevance and consistency. Then the ontology-level score is computed as a weighted average of these scores across all entities, wherein individual weights are assigned to each dimension.

Then the report generation module 220 generates granular segments of the performance score and an explanation for each entity at a plurality of levels, wherein the plurality of levels includes tables, columns, and records, wherein the explanation includes a degree of compliance of each entity with the set of predefined criteria. That is, the report generation module 220 down the performance score for each entity into granular segments (for example, tables, columns, and records). For example, the report generation module 220 decomposes each entity hierarchically, Entity (for example, table)→Attributes (for example, columns)→Instances (for example, records). For each level, local and global interpretability scores are calculated and annotated. Further, compliance score across five dimensions is calculated. Then an LLM to generate textual explanations of each score, describing strengths and deficiencies.

Furthermore, the report generation module 220 identifies a plurality of semantic attributes of the data model by analyzing the entity names, the annotations, the data properties, the object properties, and the relationships with subsequent entities to determine strengths in comprehensibility by the at least one LLM. The semantic attributes are the structural or descriptive features of the data model that convey meaning about entities, their roles, and their relationships within a domain. The report generation module 220 extracts semantic attributes from the model to identify comprehensibility strengths by analyzing the entity names, annotations, data properties, object properties and entity to entity relationships (semantic graph structure). In an embodiment, the analysis is performed using methods such as NER, semantic similarity, and LLM embeddings to detect meaningful, domain-aligned patterns.

Furthermore, the report generation module 220 identifies at least one semantic abnormality of the data model by analyzing the performance score and the explanation to determine segments of the entity names and the plurality of semantic attributes failing to meet the informativeness level, the ambiguity level, the completeness level, the relevance level, and the consistency level. To identify the semantic abnormalities, the report generation module 220 identifies the areas where interpretability scores are below a predefined threshold, for example, less than 0.6. Then the explanation is cross-referenced to identify the semantic elements (for example, entity names or fields) that are causing the abnormalities such as low informativeness (generic names such as Data1, Data2), high ambiguity (terms such as values), low completeness (missing data types or labels), low relevance (redundant fields) and low consistency (inconsistent naming conventions). In one implementation, rule-based or machine learned anomaly detections methods are employed by the report generation module 220 to identify the one or more semantic abnormality of the data model.

Upon identifying the one or more semantic abnormalities, the report generation module 220 generates the performance report including the overall ontology score, the granular segments, and the explanation for each entity, and further generates a plurality of recommendations for performing a plurality of semantic modifications based on the identified at least one semantic abnormality. In an embodiment, the report is generated in machine readable format (for example, JSON) or in human-readable format (for example PDF and HTML) or in both the formats. In an embodiment, the performance report includes the ontology score, score breakdown per entity (table, column, and record level), LLM generated explanations for each dimension per entity, list of semantic attributes and strengths, the one or more identified semantic abnormalities with contextual metadata, and scoring heatmap or a semantic graph. Hence the output of the report generation module 220 is the performance report and the report is fed into the modification determination module 225 for further processing.

In an embodiment of the present disclosure, the modification determination module 225 determines at least one semantic modification to be performed to each of the plurality of entities using an LLM, wherein the at least one semantic modification includes renaming entities, adding annotations, incorporating statistical metadata, and generating task-specific instructions for GenAI applications. Initially, the modification determination module 225 uses the performance report to identify the entities which need more attention. In one implementation, the entities are ranked filtered based on the performance scores of the entities. For example, the entities having performance score below a predefined threshold (for example less than 0.75) are filtered.

Then the modification determination module 225 generates a prompt for an LLM based on the identified entities requiring modification, wherein the prompt includes the performance report, the metadata associated with each entity, the sample data, domain-specific terms, data source descriptions, and industry-standard ontological models. An example prompt includes performance report segment for each entity (scores and explanations), entity metadata (names, types and schema details), sample data (representative rows and columns), domain specific terms (glossary or business taxonomy), data source descriptions (for example, ERP systems details related to a business), and industry-standard ontologies (schema.org). The query to the LLM may be “given the above information about a data model, suggest sematic modification to improve clarity and domain alignment, add metadata or annotations, generate task specific instruction for AI agents”. The output of the LLM may include renamed entities or fields, annotations, statistical metadata, and improved ontology alignments, and these are provided as modifications in JSON or Markdown form by the LLM.

In implementation, the prompt may include details such as:
Context: An additional contextual information, which could encompass domain or case specific terms related to the given data model.
Guidelines: An explicit delineation of the role assigned, and the approach expected from the LLM in interpreting the given information.
Task: An elaboration on the evaluation metrics, offering a granular depiction of the task at hand.
Required Output: An outline determining the elements anticipated within the output and its structure.
Examples: A set of presentative examples including input and output.
Input: A string representation of the entity under evaluation, containing all the information, ranging from the entity name and associated annotation to related data examples.

Upon receiving the response, the response having at least one semantic modification, from the LLM, the modification determination module 225 structures the at least one semantic modification in an appropriate format for application to the Gen AI application. The at least one semantic modification may include but are noted limited to renamed entities to update the informativeness level, the completeness level, the relevance level, and the consistency level, annotations to indicate contextual clarity for each entity, statistical metadata indicating data distributions of each entity, task-specific instructions for query generation and data retrieval by GenAI applications. Upon receiving the semantic modifications, the modification determination module 225 packages the responses in a format suitable for downstream GenAI applications, for example RAG systems, SQL generators, and knowledge agents. The packaging format may include but are not limited to JSON, Markdown, RDF/OWL, and SQL/DDL.

Referring to FIG. 2, upon identifying the semantics modifications, the dependency graph creation module 230 constructs a dependency graph for each entity to identify an impact of the at least one semantic modification on related entities. The dependency graph includes a plurality of relationships between the plurality of entities based on corresponding semantic connections in the data model. The dependency graph enables the system to trace and evaluate the downstream impact of semantic modifications. To construct the dependency graph, the dependency graph creation module 230 initially defines a plurality of relationships between the plurality of entities within the data model to indicate the impact of the at least one semantic modification on the related entities. The relationships define how entities depend on or interact with each other. In an embodiment, the relationships are extracted from the schema metadata (ER diagram, SQL), ontology links, data lineage tools or using embeddings or LLMs. Further, the relationships are extracted based on the foreign keys, composition/aggregation, semantics similarity, and naming or terminology dependencies. Upon determining the relationships, a graph is constructed, wherein the nodes represent the entities, and the edges represent the dependencies between the entities. It is to be noted that a directed multigraph is used if multiple relationship types exist between the same pair of entities. Further, each edge can be annotated with metadata to indicate the type and strength of dependency. The semantic graph enables the system to find the affected nodes and to Traverses downstream via edges to find impacted entities.

Upon determining the semantic modifications and constructing the semantic graph, the finetuning module 235 finetunes the data model with the at least one semantic modification. In an embodiment, the finetuning is performed based on the constructed dependency graph using a Generative Artificial Intelligence (GenAI) model. The finetuning module 235 further integrates the fine-tuned data model with at least one Generative Artificial Intelligence (GenAI) application, which is the target application where the finetuned data model will be used.

In an embodiment, the finetuning module 235 initially generates a modified data model by applying the at least one semantic modification to an intermediate semantic layer based on the constructed dependency graph. That is, the finetuning module 235 creates a working copy of the data model to apply and test the semantic modifications. The intermediate semantic layer as described herein refers to an abstract and modifiable representation of the data model which is formed to capture semantic intent. In an embodiment, the LL generated semantic modifications (for example, renames, annotations, data typing changes, etc.) are applied to the intermediate semantic layer and related entities are updated, based on the semantic graph, to maintain referential and semantic integrity. It is to be noted that the intermediate semantic layer is updated to include the semantic modifications (LLM outputs) by converting the semantic modifications into structured modification objects (e.g., JSON or dictionaries). Then the finetuning module 235 takes the structured changes and applies the changes directly to the intermediate layer using custom logic or rules-based methods.

The finetuning module 235 then feeds the modified data (updated data model) to the interpretability level determination module 210 which computes an updated performance score by re-evaluating the modified data model by reassessing modified entities and the related entities identified in the dependency graph using the scoring models and the LLM as described with references to interpretability level determination module 210 and other subsequent modules. That is, the updated data model is re-evaluated by computing the local and global scores, the performance scores, and the new metadata is passed to the LLM to get the semantic explanations as described in the present disclosure. This finetuning the modified metadata is performed to fix the inconsistencies introduced by the new or modified metadata of the updated data model. The additional contextual information is embedded into the modified data model to refine the application of the at least one semantic modification. The modified data model is iteratively updated until a termination condition is satisfied, wherein the termination condition being selected from a group comprising at least one of a local maximum, a stability threshold, and a call limit. That is, the refining is performed until no significant improvement is achievable or a control condition is reached, for example semantic modifications no longer alter related entities significantly or maximum number of LLM calls or iterations reached or no further improvement in the performance score between iterations are identified.

Upon fine tuning, that is, upon obtaining the updated data model from the finetuning module 235, the database updating module 240 updates database schemas corresponding to the fine-tuned data model based on the integrated Generative Artificial Intelligence (GenAI) application. That is, the database updating module 240 updates the actual database schemas of the given data model to reflect the fine-tuned data model. For example, the original schema of the data model is compared with the modified intermediate semantic model and migration methods are employed for updating the updated data model.

Upon updating the modified/updated/finetuned data model, the GenAI integration module 245 prepares the finetuned data model so that the GenAI system may understand and interact with the finetuned data model semantically. That is, the GenAI integration module 245 enables access to the finetuned data model, enables interpretation of user questions and determines what data to fetch, without manual query writing, translates the interpreted natural language into valid and executable SQL queries, runs the generated SQL query on the modified data model and return results to the user or downstream GenAI applications.

In an embodiment of the present disclosure, the database updating module 240 is further configured to identify a language of each entity name in the data model using language detection model, classify a domain associated with each entity in the data model into a plurality of domains using a domain classification model, generate a descriptive textual data for each entity to indicate a type of data stored in the entity, embed the identified language, the classified domain, and the generated descriptive textual data into the data model for the at least one Large Language Model (LLM), and perform at least one task comprising generating executable database queries and data discovery for Generative Artificial Intelligence (GenAI) applications based on the embedded language, the domain, and the generated descriptive textual data. This enhances the data model by augmenting each entity with semantically rich metadata, making the data model more suitable for tasks like query generation and data discovery by Generative AI (GenAI) systems. This helps GenAI models disambiguate terms, understand naming conventions, and improve multilingual performance. To achieve this, the database updating module 240 determines the natural language of each entity name in the data model, for example using a pre-trained language detection models such as a transformer-based model. Then the database updating module 240 classifies the domain associated with the entity, for example using domain classification model trained on labeled datasets mapping entity metadata to business or technical domains. Further, the module 240 generates a description for each entity, for example using an LLM, to enrich the schema with semantic information that LLMs (the LLMs using the data model) may use for understanding data purpose and structure. Upon determining the natural language, the domain and the description of the entities, the database updating module 240 integrates the detected language, classified domain, and generated description into the data model. That is, the module 240 extends the schema representation to include the detected language, the domain and the description. This transforms the data model into an LLM-friendly format, enabling better performance in downstream tasks.

As described, the system disclosed in the present disclosure enhances the existing data models by refining the entities and associated metadata and fields, thereby facilitating improved automatic processing capabilities, including enhanced comprehension by the LLMs. Particularly, the prosed system evaluates the readiness of information systems for integration with GenAI applications by measuring their underlying data models' comprehensibility to LLMs. Further, the system calculates various quality metrics and produces a detailed report at various granularity levels to determine the comprehensibility of the data models and generates a detailed report with total scores and actionable insights. Using an intermediate semantic layer of the data model, the system automatically makes refinements and optimizations that are well understood by LLMs and thereby facilitates integration with GenAI applications. The intermediate semantic layer can be then used to create an interface to and from GenAI applications, or alternatively, the sematic layer can be used to transform the underlying data models.

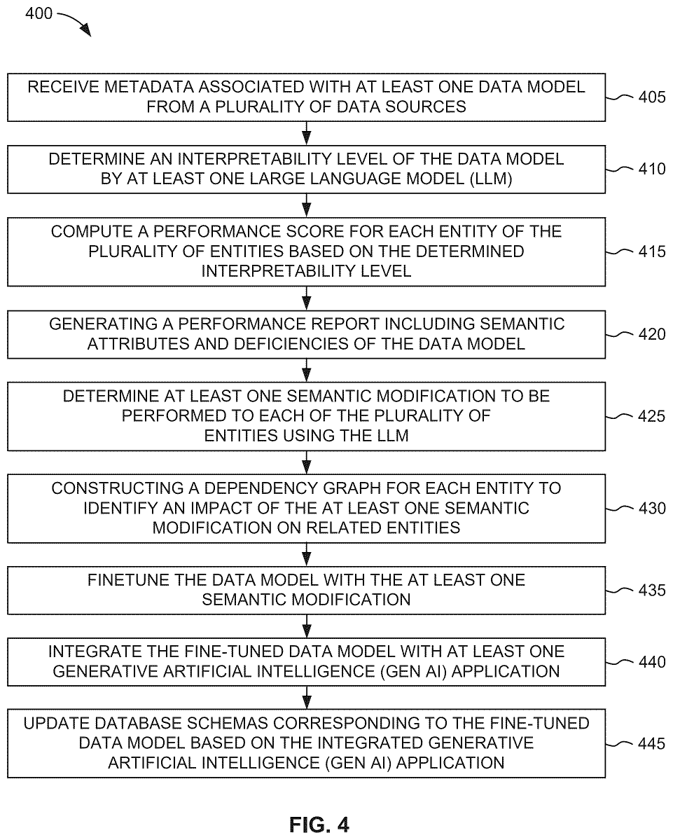

FIG. 4 is a flowchart illustrating a method for assessing and improving data interoperability of large-language-models, in accordance with an embodiment of the present disclosure. As shown, at step 405, the system 115 receives metadata associated with at least one data model from a plurality of data sources, wherein the at least one data model includes a plurality of entities comprising classes, data properties, and object properties. The data model as described herein refers to a structure that defines how data is stored, organized, and related in a system, usually for databases, applications, or software systems.

At step 410, the system 115 determines the interpretability level of the data model by at least one Large Language Model (LLM). In an embodiment, the interpretability level of the data model is determined by evaluating the plurality of entities based on a set of predefined criteria, wherein the set of predefined criteria includes an informativeness level, an ambiguity level, a completeness level, a relevance level, and a consistency level. In an embodiment, to determine the interpretability level of the data model the system 115 accesses the metadata associated with the data model, wherein the metadata includes entity names, annotations, data properties, object properties, sample data, domain-specific terms, and relationships with other entities. Then the system processes the accessed metadata and determines informativeness level of the data model, ambiguity level of the data model, completeness level of the data model, relevance level of the data model and the consistency level of the data model, as described with reference to FIG. 3 of the present disclosure. It is to be noted that these levels are determined for each entity and scores are assigned. Then the system embeds additional contextual information into the data model, wherein the additional contextual information includes data source descriptions and data retrieved from external sources. Then the system 115 determines the interpretability level of the data model by at least one Large Language Model (LLM) by evaluating the entity names based on the embedded additional contextual information, the informativeness level, the ambiguity level, the completeness level, the relevance level, and the consistency level.

Upon determining the interpretability level, the system 115 computes a performance score for each entity of the plurality of entities based on the determined interpretability level as shown at step 415. The performance score includes a numerical score and an explanation for each entity based on the set of predefined criteria. To computing the performance score for each entity of the plurality of entities based on the determined interpretability level, the system 115 uses the numerical score assigned each entity, the numerical scores assigned for informativeness level, the ambiguity level, the completeness level, the relevance level, and the consistency level. Then the system 115 generates an explanation for each of the assigned numerical scores using an LLM, wherein the explanation includes a degree of compliance of each entity with the informativeness level, the ambiguity level, the completeness level, the relevance level, and the consistency level. Further, the system 115 computes a plurality of local scores for each entity independently of subsequent entities in the data model and a plurality of global scores for each entity relative to the subsequent entities in the data model based on inter-entity relationships, wherein the inter-entity relationships include semantic connections affecting the ambiguity level and the consistency level. Then the system 115 aggregates the local scores, and the global scores to generate the performance score for each entity, wherein the performance score indicates the interpretability level of the entity within the data model. The way the scores are assigned and aggregated is described in detail with reference to the performance scoring module 215 of FIG. 2.

Upon computing the performance score, the system 115 generates a performance report comprising semantic attributes and deficiencies of the data model, wherein the readiness report includes an overall ontology score calculated as a weighted average of the computed performance score assigned to the plurality of entities. In an embodiment, the system 115 aggregates the performance score for each entity of the plurality of entities to calculate an overall ontology score as the weighted average based on the informativeness level, the ambiguity level, the completeness level, the relevance level, and the consistency level, and generates granular segments of the performance score and an explanation for each entity at a plurality of levels, wherein the plurality of levels include tables, columns, and records, wherein the explanation comprises a degree of compliance of each entity with the set of predefined criteria. Then the system 115 identifies a plurality of semantic attributes of the data model by analyzing the entity names, the annotations, the data properties, the object properties, and the relationships with subsequent entities to determine strengths in comprehensibility by the LLM. The system 115 further identifies at least one semantic abnormality of the data model by analyzing the performance score and the explanation to determine segments of the entity names and the plurality of semantic attributes failing to meet the informativeness level, the ambiguity level, the completeness level, the relevance level, and the consistency level. Then the system 115 generates the performance report including the overall ontology score, the granular segments, and the explanation for each entity and generates a plurality of recommendations for performing a plurality of semantic modifications based on the identified at least one semantic abnormality. The way the performance report is generated and what the performance report includes is described in detail with reference to the report generation module 220 of FIG. 2.

At step 425, the system 115 determines at least one semantic modification to be performed to each of the plurality of entities, wherein the at least one semantic modification includes renaming entities, adding annotations, incorporating statistical metadata, and generating task-specific instructions for GenAI applications. To determine the at least one semantic modification to be performed to each of the plurality of entities, the system 115 initially prioritizes the entities of the plurality of entities based on the performance score from the performance report to identify entities requiring modification and generates a prompt for an LLM based on the identified entities requiring modification, wherein the prompt includes the performance report, the metadata associated with each entity, the sample data, domain-specific terms, data source descriptions, and industry-standard ontological models. Then the system 115 receives responses including at least one semantic modification from the LLM, the at least one semantic modification including renamed entities to update the informativeness level, the completeness level, the relevance level, and the consistency level, annotations to indicate contextual clarity for each entity, statistical metadata indicating data distributions of each entity, task-specific instructions for query generation and data retrieval by GenAI applications. Then the system 115 structures the at least one semantic modification in an appropriate format for application to the Gen AI application. The way the semantic modifications are identified and structured is described in detail with reference to the modification determination module 225 of FIG. 2.

At step 430, the system 115 constructs a dependency graph for each entity to identify an impact of the at least one semantic modification on related entities, wherein the dependency graph includes a plurality of relationships between the plurality of entities based on corresponding semantic connections in the data model. In an embodiment, the system 115 defines the plurality of relationships between the plurality of entities within the data model to indicate the impact of the at least one semantic modification on the related entities and then generates the dependency graph for each entity to connect the plurality of entities based on the semantic relationships in the data model. The way the semantic graph is generated is described in detail with reference to the semantic graph generation module 230 of FIG. 2.

Upon generating the semantic graph, the system 115 fine-tunes the data model with the at least one semantic modification based on the constructed dependency graph using a Generative Artificial Intelligence model, as shown at step 435. To finetune the data model, the system 115 generates the modified data model by applying the at least one semantic modification to an intermediate semantic layer based on the constructed dependency graph. Then the system 115 computes an updated performance score by re-evaluating the modified data model by reassessing modified entities and the related entities identified in the dependency graph using a scoring model and the LLM. Further, the system 115 embeds additional contextual information into the modified data model to refine the application of the at least one semantic modification and iteratively updates the modified data model until a termination condition is satisfied, wherein the termination condition being selected from a group including at least one of a local maximum, a stability threshold, and a call limit. The way the semantic graph is generated is described in detail with reference to the semantic graph generation module 230 of FIG. 2.

Upon finetuning, the system 115 integrates the fine-tuned data model with at least one Generative Artificial Intelligence (Gen AI) application, as shown at step 442. To integrate the finetuned data model with the GenAI application, the system 115 configures the modified data model to interface with the Gen AI application and performs autonomous data retrieval from the modified data model based on natural language user inputs. Further, the system 115 generates executable database queries from natural language questions, wherein the executable database queries being executed at the modified data model to retrieve corresponding datasets appropriate for the Gen AI application.

At step 445, the system 115 updates database schemas corresponding to the fine-tuned data model based on the integrated Generative Artificial Intelligence (Gen AI) application. That is, the system 115 updates the actual database schemas of the given data model to reflect the fine-tuned data model. For example, the original schema of the data model is compared with the modified intermediate semantic model and migration methods are employed for updating the updated data model.

In an embodiment of the present disclosure, the system 115 configured to identify a language of each entity name in the data model using language detection model, classify a domain associated with each entity in the data model into a plurality of domains using a domain classification model, generate a descriptive textual data for each entity to indicate a type of data stored in the entity, embed the identified language, the classified domain, and the generated descriptive textual data into the data model for the at least one Large Language Model (LLM), and perform at least one task comprising generating executable database queries and data discovery for Generative Artificial Intelligence (GenAI) applications based on the embedded language, the domain, and the generated descriptive textual data. This enhances the data model by augmenting each entity with semantically rich metadata, making the data model more suitable for tasks like query generation and data discovery by Generative AI (GenAI) systems. This helps GenAI models disambiguate terms, understand naming conventions, and improve multilingual performance.

As described, the system and method disclosed in the present disclosure enhances the existing data models by refining the entities and associated metadata and fields, thereby facilitating improved automatic processing capabilities, including enhanced comprehension by the LLMs. The proposed system and method may be used to enhance the existing suboptimal data models (suboptimal due to the factors such as ambiguous entity names, unclear annotations and inappropriate or imprecise relationship definitions or combinations thereof.) by refining the elements to meet the requirements of the GenAI applications. Particularly, the prosed system evaluates the readiness of information systems for integration with GenAI applications by measuring their underlying data models' comprehensibility to LLMs. The proposed system and method provide an improved data quality and streamlined integration with LLMs which mitigates the business risk of not being able to utilize GenAI applications. Furthermore, by applying proposed methods to critical business processes, businesses may achieve a competitive edge, reduce time-to-market, and realize increased operational efficiencies.

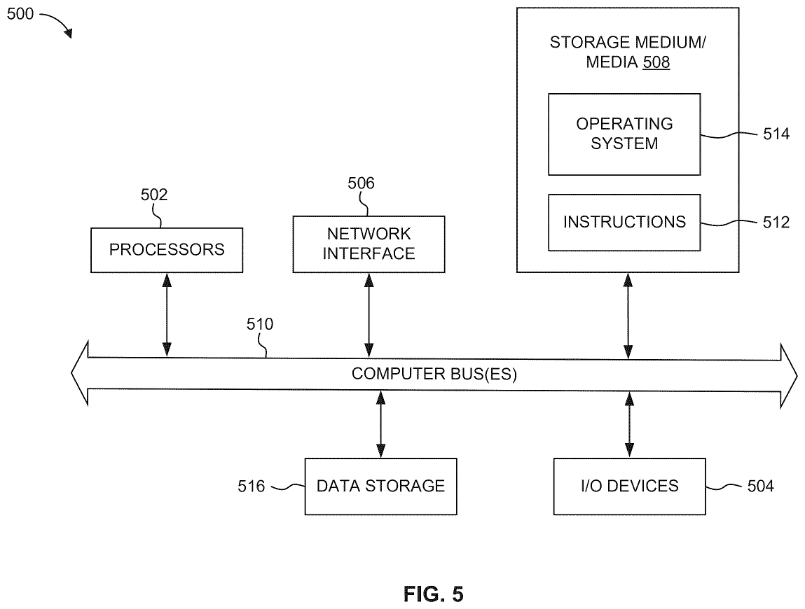

FIG. 5 illustrates a computer system that may be used to implement the system disclosed in the present disclosure. More particularly, computing machines such as desktops, laptops, and servers, which may be used to process the conversational interactions in the system 114 may have the structure of the computer system 500. The computer system 500 may include additional components not shown and that some of the process components described may be removed and/or modified. In another example, a computer system 500 may be deployed on external-cloud platforms such as cloud, internal corporate cloud computing clusters, organizational computing resources, and/or the like.

The computer system 500 includes processor(s) 502, such as a central processing unit, ASIC or another type of processing circuit, input/output devices 504, such as a display, mouse keyboard, etc., a network interface 506, such as a Local Area Network (LAN), a wireless 902.11x LAN, a 3G or 4G mobile WAN or a WiMax WAN, and a processor-readable medium 508. Each of these components may be operatively coupled to a bus 510.

The computer-readable medium 508 may be any suitable medium that participates in providing instructions to the processor(s) 502 for execution. For example, the computer-readable medium 508 may be non-transitory or non-volatile medium, such as a magnetic disk or solid-state non-volatile memory or volatile medium such as RAM. The instructions or modules stored on the computer-readable medium 508 may include machine-readable instructions 512 executed by the processor(s) 502 that cause the processor(s) 502 to perform the methods and functions of the system 514.

The system 514 may be implemented as software stored on a non-transitory processor-readable medium and executed by the processors 502. For example, the computer-readable medium 508 may store an operating system 514, such as MAC OS, MS WINDOWS, UNIX, or LINUX, and code for the system 514. The operating system 514 may be multi-user, multiprocessing, multitasking, multithreading, real-time, and the like. For example, during runtime, the operating system 514 is running and the code for the system 514 is executed by the processor(s) 502.

The computer system 500 may include a data storage 516, which may include non-volatile data storage. The data storage 516 stores any data used or generated by the system 115. The network interface 506 connects the computer system 500 to internal systems for example, via a LAN. Also, the network interface 506 may connect the computer system 500 to the Internet. For example, the computer system 500 may connect to web browsers and other external applications and systems via the network interface 506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination with a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory storing instructions that, when executed by the processor, cause the system to:
receive metadata associated with at least one data model from a plurality of data sources, wherein the at least one data model comprises a plurality of entities comprising classes, data properties, and object properties;
determine an interpretability level of the data model by at least one Large Language Model (LLM) by evaluating the plurality of entities based on a set of predefined criteria, wherein the set of predefined criteria comprises an informativeness level, an ambiguity level, a completeness level, a relevance level, and a consistency level;
compute a performance score for each entity of the plurality of entities based on the determined interpretability level, wherein the performance score comprises a numerical score and an explanation for each entity based on the set of predefined criteria;
generate a performance report comprising semantic attributes and deficiencies of the data model, wherein the readiness report comprises an overall ontology score calculated as a weighted average of the computed performance score assigned to the plurality of entities;
determine at least one semantic modification to be performed to each of the plurality of entities using the LLM, wherein the at least one semantic modification comprise renaming entities, adding annotations, incorporating statistical metadata, and generating task-specific instructions for GenAI applications;
construct a dependency graph for each entity to identify an impact of the at least one semantic modification on related entities, wherein the dependency graph comprises a plurality of relationships between the plurality of entities based on corresponding semantic connections in the data model;
fine-tune the data model with the at least one semantic modification based on the constructed dependency graph using a Generative Artificial Intelligence model;
integrate the fine-tuned data model with at least one Generative Artificial Intelligence (Gen AI) application; and
update database schemas corresponding to the fine-tuned data model based on the integrated Generative Artificial Intelligence (Gen AI) application.

2. The system of claim 1, wherein to determine the interpretability level of the data model by at least one Large Language Model (LLM) by evaluating the plurality of entities based on the set of predefined criteria, the processor is to:
access the metadata associated with the data model, wherein the metadata comprises entity names, annotations, data properties, object properties, sample data, domain-specific terms, and relationships with other entities;
process the accessed metadata to assess the informativeness level of the data model by determining each entity name and associated attributes indicating a purpose of the entity using the LLM;
process the accessed metadata to assess the ambiguity level of the data model by determining each entity name comprising multiple interpretations, evaluated independently and relatively to the plurality of entities in the data model using the LLM;
process the accessed metadata to assess the completeness level of the data model by determining each entity name indicating data represented by the entity using the LLM;
process the accessed metadata to assess the relevance level of the data model by determining each entity name corresponding to data attributes of the entity using the LLM;
process the accessed metadata to assess the consistency level of the data model by determining entity names being uniformly applied across the data model to indicate similar concepts using the LLM;
embed additional contextual information into the data model, wherein the additional contextual information comprises data source descriptions and data retrieved from external sources; and
determine the interpretability level of the data model by at least one Large Language Model (LLM) by evaluating the entity names based on the embedded additional contextual information, the informativeness level, the ambiguity level, the completeness level, the relevance level, and the consistency level.

3. The method of claim 1, wherein to compute the performance score for each entity of the plurality of entities based on the determined interpretability level, the processor is to:
assign the numerical score to each entity based on the informativeness level, the ambiguity level, the completeness level, the relevance level, and the consistency level;
generate an explanation for each of the assigned numerical score using the LLM, wherein the explanation comprises a degree of compliance of each entity with the informativeness level, the ambiguity level, the completeness level, the relevance level, and the consistency level;
compute a plurality of local scores for each entity independently of subsequent entities in the data model;
compute a plurality of global scores for each entity relative to the subsequent entities in the data model based on inter-entity relationships, wherein the inter-entity relationships comprise semantic connections affecting the ambiguity level and the consistency level; and
aggregate the local scores and the global scores to generate the performance score for each entity, wherein the performance score indicates the interpretability level of the entity within the data model.

4. The system of claim 1, wherein to generate the performance report comprising semantic attributes and deficiencies of the data model, the processor is to:
aggregate the performance score for each entity of the plurality of entities to calculate an overall ontology score as the weighted average based on the informativeness level, the ambiguity level, the completeness level, the relevance level, and the consistency level;
generate granular segments of the performance score and an explanation for each entity at a plurality of levels, wherein the plurality of levels comprise tables, columns, and records, wherein the explanation comprises a degree of compliance of each entity with the set of predefined criteria;
identify a plurality of semantic attributes of the data model by analyzing the entity names, the annotations, the data properties, the object properties, and the relationships with subsequent entities to determine strengths in comprehensibility for the at least one Large Language Model (LLM);
identify at least one semantic abnormality of the data model by analyzing the performance score and the explanation to determine segments of the entity names and the plurality of semantic attributes failing to meet the informativeness level, the ambiguity level, the completeness level, the relevance level, and the consistency level;
generate the performance report comprising the overall ontology score, the granular segments, and the explanation for each entity; and
generate a plurality of recommendations for performing a plurality of semantic modifications based on the identified at least one semantic abnormality.

5. The system of claim 1, wherein to determine the at least one semantic modification to be performed to each of the plurality of entities using the LLM, the processor is to:
prioritize entities of the plurality of entities based on the performance score from the performance report to identify entities requiring modification;
generate a prompt for the LLM based on the identified entities requiring modification, wherein the prompt comprises the performance report, the metadata associated with each entity, the sample data, domain-specific terms, data source descriptions, and industry-standard ontological models;
receive responses comprising at least one semantic modification from the LLM, the at least one semantic modification comprising renamed entities to update the informativeness level, the completeness level, the relevance level, and the consistency level, annotations to indicate contextual clarity for each entity; statistical metadata indicating data distributions of each entity, task-specific instructions for query generation and data retrieval by GenAI applications; and
structure the at least one semantic modification in an appropriate format for application to the at least one Gen AI application.

6. The system of claim 1, wherein to construct the dependency graph for each entity to identify the impact of the at least one semantic modification on the related entities, the processor is to:
define the plurality of relationships between the plurality of entities within the data model to indicate the impact of the at least one semantic modification on the related entities; and
generate the dependency graph for each entity to connect the plurality of entities based on the semantic relationships in the data model.

7. The system of claim 1, wherein to fine-tune the data model with the at least one semantic modification based on the constructed dependency graph using the Generative Artificial Intelligence model, the processor is to:
generate a modified data model by applying the at least one semantic modification to an intermediate semantic layer based on the constructed dependency graph;
compute an updated performance score by re-evaluating the modified data model by reassessing modified entities and the related entities identified in the dependency graph using a scoring model and the LLM;
embed additional contextual information into the modified data model to refine the application of the at least one semantic modification; and
iteratively update the modified data model until a termination condition is satisfied, wherein the termination condition being selected from a group comprising at least one of a local maximum, a stability threshold, and a call limit.

8. The system of claim 1, wherein the processor is further to:
identify a language of each entity name in the data model using language detection model;
classify a domain associated with each entity in the data model into a plurality of domains using a domain classification model;
generate a descriptive textual data for each entity to indicate a type of data stored in the entity;
embed the identified language, the classified domain, and the generated descriptive textual data into the data model for the at least one Large Language Model (LLM); and
perform at least one task comprising generating executable database queries and data discovery for Generative Artificial Intelligence (GenAI) applications based on the embedded language, the domain, and the generated descriptive textual data.

9. The system of claim 1, wherein to integrate the fine-tuned data model with at least one Generative Artificial Intelligence (Gen AI) application, the processor is to:
configure the modified data model to interface with the at least one Generative Artificial Intelligence (Gen AI) application;
perform autonomous data retrieval from the modified data model based on natural language user inputs; and
generate executable database queries from natural language questions, wherein the executable database queries being executed at the modified data model to retrieve corresponding datasets appropriate for the at least one Generative Artificial Intelligence (Gen AI) application.

10. A method comprising:
receiving, by a processor, metadata associated with at least one data model from a plurality of data sources, wherein the at least one data model comprises a plurality of entities comprising classes, data properties, and object properties;
determining, by the processor, an interpretability level of the data model by at least one Large Language Model (LLM) by evaluating the plurality of entities based on a set of predefined criteria, wherein the set of predefined criteria comprises an informativeness level, an ambiguity level, a completeness level, a relevance level, and a consistency level;
computing, by the processor, a performance score for each entity of the plurality of entities based on the determined interpretability level, wherein the performance score comprises a numerical score and an explanation for each entity based on the set of predefined criteria;
generating, by the processor, a performance report comprising semantic attributes and deficiencies of the data model, wherein the readiness report comprises an overall ontology score calculated as a weighted average of the computed performance score assigned to the plurality of entities;
determining, by the processor, at least one semantic modification to be performed to each of the plurality of entities using the LLM, wherein the at least one semantic modification comprise renaming entities, adding annotations, incorporating statistical metadata, and generating task-specific instructions for GenAI applications;
constructing, by the processor, a dependency graph for each entity to identify an impact of the at least one semantic modification on related entities, wherein the dependency graph comprises a plurality of relationships between the plurality of entities based on corresponding semantic connections in the data model;
fine-tuning, by the processor, the data model with the at least one semantic modification based on the constructed dependency graph using a Generative Artificial Intelligence model;
integrating, by the processor, the fine-tuned data model with at least one Generative Artificial Intelligence (Gen AI) application; and
updating, by the processor, database schemas corresponding to the fine-tuned data model based on the integrated Generative Artificial Intelligence (Gen AI) application.

11. The method of claim 10, wherein determining the interpretability level of the data model by at least one Large Language Model (LLM) by evaluating the plurality of entities based on the set of predefined criteria comprises:
accessing, by the processor, the metadata associated with the data model, wherein the metadata comprises entity names, annotations, data properties, object properties, sample data, domain-specific terms, and relationships with other entities;
processing, by the processor, the accessed metadata to assess the informativeness level of the data model by determining each entity name and associated attributes indicating a purpose of the entity using the LLM;
processing, by the processor, the accessed metadata to assess the ambiguity level of the data model by determining each entity name comprising multiple interpretations, evaluated independently and relatively to the plurality of entities in the data model using the LLM;
processing, by the processor, the accessed metadata to assess the completeness level of the data model by determining each entity name indicating data represented by the entity using the LLM;
processing, by the processor, the accessed metadata to assess the relevance level of the data model by determining each entity name corresponding to data attributes of the entity using the LLM;
processing, by the processor, the accessed metadata to assess the consistency level of the data model by determining entity names being uniformly applied across the data model to indicate similar concepts using the LLM;
embedding, by the processor, additional contextual information into the data model, wherein the additional contextual information comprises data source descriptions and data retrieved from external sources; and
determining, by the processor, the interpretability level of the data model by at least one Large Language Model (LLM) by evaluating the entity names based on the embedded additional contextual information, the informativeness level, the ambiguity level, the completeness level, the relevance level, and the consistency level.

12. The method of claim 10, wherein computing the performance score for each entity of the plurality of entities based on the determined interpretability level comprises:
assigning, by the processor, the numerical score to each entity based on the informativeness level, the ambiguity level, the completeness level, the relevance level, and the consistency level;
generating, by the processor, an explanation for each of the assigned numerical score using the LLM, wherein the explanation comprises a degree of compliance of each entity with the informativeness level, the ambiguity level, the completeness level, the relevance level, and the consistency level;
computing, by the processor, a plurality of local scores for each entity independently of subsequent entities in the data model;
computing, by the processor, a plurality of global scores for each entity relative to the subsequent entities in the data model based on inter-entity relationships, wherein the inter-entity relationships comprise semantic connections affecting the ambiguity level and the consistency level; and
aggregating, by the processor, the local scores, and the global scores to generate the performance score for each entity, wherein the performance score indicates the interpretability level of the entity within the data model.

13. The method of claim 10, wherein generating the performance report comprising semantic attributes and deficiencies of the data model comprises:
aggregating, by the processor, the performance score for each entity of the plurality of entities to calculate an overall ontology score as the weighted average based on the informativeness level, the ambiguity level, the completeness level, the relevance level, and the consistency level;
generating, by the processor, granular segments of the performance score and an explanation for each entity at a plurality of levels, wherein the plurality of levels comprise tables, columns, and records, wherein the explanation comprises a degree of compliance of each entity with the set of predefined criteria;
identifying, by the processor, a plurality of semantic attributes of the data model by analyzing the entity names, the annotations, the data properties, the object properties, and the relationships with subsequent entities to determine strengths in comprehensibility for the at least one Large Language Model (LLM);
identifying, by the processor, at least one semantic abnormality of the data model by analyzing the performance score and the explanation to determine segments of the entity names and the plurality of semantic attributes failing to meet the informativeness level, the ambiguity level, the completeness level, the relevance level, and the consistency level;
generating, by the processor, the performance report comprising the overall ontology score, the granular segments, and the explanation for each entity; and
generating, by the processor, a plurality of recommendations for performing a plurality of semantic modifications based on the identified at least one semantic abnormality.

14. The method of claim 10, wherein determining the at least one semantic modification to be performed to each of the plurality of entities using the LLM comprises:
prioritizing, by the processor, entities of the plurality of entities based on the performance score from the performance report to identify entities requiring modification;
generating, by the processor, a prompt for the LLM based on the identified entities requiring modification, wherein the prompt comprises the performance report, the metadata associated with each entity, the sample data, domain-specific terms, data source descriptions, and industry-standard ontological models;
receiving, by the processor, responses comprising at least one semantic modification from the LLM, the at least one semantic modification comprising renamed entities to update the informativeness level, the completeness level, the relevance level, and the consistency level, annotations to indicate contextual clarity for each entity; statistical metadata indicating data distributions of each entity, task-specific instructions for query generation and data retrieval by GenAI applications; and
structuring, by the processor, the at least one semantic modification in an appropriate format for application to the at least one Gen AI application.

15. The method of claim 10, wherein constructing the dependency graph for each entity to identify the impact of the at least one semantic modification on the related entities comprises:
defining, by the processor, the plurality of relationships between the plurality of entities within the data model to indicate the impact of the at least one semantic modification on the related entities; and
generating, by the processor, the dependency graph for each entity to connect the plurality of entities based on the semantic relationships in the data model.

16. The method of claim 10, wherein fine-tuning the data model with the at least one semantic modification based on the constructed dependency graph using the Generative Artificial Intelligence model comprises:
generating, by the processor, the modified data model by applying the at least one semantic modification to an intermediate semantic layer based on the constructed dependency graph;
computing, by the processor, an updated performance score by re-evaluating the modified data model by reassessing modified entities and the related entities identified in the dependency graph using a scoring model and the LLM;
embedding, by the processor, additional contextual information into the modified data model to refine the application of the at least one semantic modification; and
iteratively updating, by the processor, the modified data model until a termination condition is satisfied, wherein the termination condition being selected from a group comprising at least one of a local maximum, a stability threshold, and a call limit.

17. The method of claim 10, further comprising:
identifying, by the processor, a language of each entity name in the data model using language detection model;
classifying, by the processor, a domain associated with each entity in the data model into a plurality of domains using a domain classification model;
generating, by the processor, a descriptive textual data for each entity to indicate a type of data stored in the entity;
embedding, by the processor, the identified language, the classified domain, and the generated descriptive textual data into the data model for the at least one Large Language Model (LLM); and
performing, by the processor, at least one task comprising generating executable database queries and data discovery for Generative Artificial Intelligence (GenAI) applications based on the embedded language, the domain, and the generated descriptive textual data.

18. The method of claim 10, wherein integrating the fine-tuned data model with the at least one Generative Artificial Intelligence (Gen AI) application comprises:
configuring, by the processor, the modified data model to interface with the at least one Generative Artificial Intelligence (Gen AI) application;
performing, by the processor, autonomous data retrieval from the modified data model based on natural language user inputs; and
generating, by the processor, executable database queries from natural language questions, wherein the executable database queries being executed at the modified data model to retrieve corresponding datasets appropriate for the at least one Generative Artificial Intelligence (Gen AI) application.

19. A non-transitory computer readable medium comprising a processor-executable instructions that cause a processor to:
receive metadata associated with at least one data model from a plurality of data sources, wherein the at least one data model comprises a plurality of entities comprising classes, data properties, and object properties;
determine an interpretability level of the data model by at least one Large Language Model (LLM) by evaluating the plurality of entities based on a set of predefined criteria, wherein the set of predefined criteria comprises an informativeness level, an ambiguity level, a completeness level, a relevance level, and a consistency level;
compute a performance score for each entity of the plurality of entities based on the determined interpretability level, wherein the performance score comprises a numerical score and an explanation for each entity based on the set of predefined criteria;
generate a performance report comprising semantic attributes and deficiencies of the data model, wherein the readiness report comprises an overall ontology score calculated as a weighted average of the computed performance score assigned to the plurality of entities;
determine at least one semantic modification to be performed to each of the plurality of entities using the LLM, wherein the at least one semantic modification comprise renaming entities, adding annotations, incorporating statistical metadata, and generating task-specific instructions for GenAI applications;
construct a dependency graph for each entity to identify an impact of the at least one semantic modification on related entities, wherein the dependency graph comprises a plurality of relationships between the plurality of entities based on corresponding semantic connections in the data model;
fine-tune the data model with the at least one semantic modification based on the constructed dependency graph using a Generative Artificial Intelligence model;
integrate the fine-tuned data model with at least one Generative Artificial Intelligence (Gen AI) application; and
update database schemas corresponding to the fine-tuned data model based on the integrated Generative Artificial Intelligence (Gen AI) application.

20. The non-transitory computer readable medium of claim 19, wherein to determine the interpretability level of the data model by at least one Large Language Model (LLM) by evaluating the plurality of entities based on the set of predefined criteria, the processor-executable instructions cause the processor to:
access the metadata associated with the data model, wherein the metadata comprises entity names, annotations, data properties, object properties, sample data, domain-specific terms, and relationships with other entities;
process the accessed metadata to assess the informativeness level of the data model by determining each entity name and associated attributes indicating a purpose of the entity using the LLM;
process the accessed metadata to assess the ambiguity level of the data model by determining each entity name comprising multiple interpretations, evaluated independently and relatively to the plurality of entities in the data model using the LLM;
process the accessed metadata to assess the completeness level of the data model by determining each entity name indicating data represented by the entity using the LLM;
process the accessed metadata to assess the relevance level of the data model by determining each entity name corresponding to data attributes of the entity using the LLM;
process the accessed metadata to assess the consistency level of the data model by determining entity names being uniformly applied across the data model to indicate similar concepts using the LLM;
embed additional contextual information into the data model, wherein the additional contextual information comprises data source descriptions and data retrieved from external sources; and
determine the interpretability level of the data model by at least one Large Language Model (LLM) by evaluating the entity names based on the embedded additional contextual information, the informativeness level, the ambiguity level, the completeness level, the relevance level, and the consistency level.
